(19) United States
(12) Patent Application Publication
(10) Pub. No.: US 2016/0303951 A1
(43) Pub. Date: Oct. 20, 2016

(54) UNIVERSAL AUTOMATED SHADE FOR A VEHICULAR WINDSHIELD TO BLOCK THE ENTRANCE OF SUNLIGHT

(71) Applicants: Obaid Masih, Rowlett, TX (US); Onkar Modgil, Plano, TX (US); Michael Wuensch, Carrolton, TX (US)

(72) Inventors: Obaid Masih, Rowlett, TX (US); Onkar Modgil, Plano, TX (US); Michael Wuensch, Carrolton, TX (US)

(21) Appl. No.: 15/014,187

(22) Filed: Feb. 3, 2016

Related U.S. Application Data
(60) Provisional application No. 62/147,961, filed on Apr. 15, 2015.

(51) Int. Cl. B60J 3/02

(52) U.S. Cl. CPC B60J 3/026; B60J 3/0217

(57) ABSTRACT

An automated shade apparatus for a vehicle's windshield includes a housing having a pair of openings, a drive assembly disposed within the housing and having a belt disposed around rollers, at least one of the rollers driven by a motor, a retractable shade roller coupled to the housing and having a sheet disposed around the shade roller, and a collapsible scissor arm assembly coupled to the housing and having a plurality of arms with a pair of top ends disposed through the housing openings and coupled to the belt and a pair of bottom ends coupled to the sheet. The motor drives the belt in a first direction to extend the arms, thereby deploying the sheet over the windshield. The motor drives the belt in a second direction to collapse the arms, thereby retracting the sheet around the shade roller to expose the windshield.

### RELATED APPLICATION

The application claims priority to provisional patent application U.S. Ser. No. 62/147,961 filed on Apr. 15, 2015, the entire contents of which is herein incorporated by reference.

### BACKGROUND

The embodiments herein relate generally to shades or cover devices used to block sunlight from entering through a vehicle's windshield.

A variety of covers have long been developed to serve as barriers to heat energy and/or to direct exposure to infrared, ultraviolet (“UV”), and visible portions of the solar spectrum. Methods of deploying these covers have likewise been developed to facilitate deployment and increase effectiveness. However, various concerns relating to conventional covers remain in the art.

In automotive settings, for example, inside cover designs are typically deployed manually, thereby requiring the presence of an occupant. Where an occupant is not present, the cover cannot be deployed. As a result, excessive temperature rise (and direct exposure of interior surfaces to solar radiation) in parked vehicles due to solar energy passing through glazing often occur rapidly, resulting at least in an unpleasant situation upon vehicle entry and more rapid degradation of UV sensitive interior materials.

Similarly, outside sunshades that typically overlay an entire glazing region, such as the front or rear windshield of a vehicle, have long been utilized to block the infiltration of radiant heat energy from the sun. Concerns remain here as well, as the manual deployment and stowing of these larger shades take even more time, are inconvenient, and when not in use require significant storage space.

More recently, vehicle covers having automatic deployment mechanisms have also been developed to reduce operation time and operator contributed energy. The electro-mechanical motors involved therewith, however, present their own concerns related to increased weight, volume, cost, noise, and likelihood of failure. Moreover, these types of mechanisms further present concerns related to up-keep, repair and replacement, as well as the establishment of an additional battery load.

As such, there is a need in the industry for a universal automated shade for a vehicle's windshield, which overcomes the limitations of the prior art.

### SUMMARY

An automated shade apparatus detachably coupled to a windshield of a vehicle and configured to deploy or retract with enhanced efficiency is provided. The shade apparatus is configured to permit a user to control the amount of sunlight that enters the vehicle with reduced user effort. The shade apparatus comprises a housing coupled to the windshield of the vehicle, the housing comprising a pair of openings both extending along a longitudinal axis of the housing, a drive assembly disposed within the housing and comprising a belt disposed around a pair of rollers, at least one of the rollers configured to be driven by a motor to permit the belt to travel around the rollers, a retractable shade roller coupled to the housing and comprising a sheet disposed around the shade roller, and a collapsible scissor arm assembly coupled to the housing and comprising a plurality of arms pivotably mounted together, the plurality of arms comprising a pair of top ends disposed through the pair of openings in the housing and coupled to the belt and a pair of bottom ends coupled to an end of the sheet.

The motor is configured to drive the belt in a first direction to extend the plurality of arms, thereby deploying the sheet over the windshield. The motor is configured to drive the belt in a second direction to collapse the plurality of arms, thereby retracting the sheet around the shade roller to expose the windshield.

In certain embodiments of the invention, the shade apparatus comprises a retractable shade roller coupled to the housing and comprising a sheet disposed around the shade roller, and a motor operably connected to the retractable shade roller, wherein the motor is configured to rotate the shade roller in a first direction to deploy the sheet to cover any portion of the windshield, wherein the motor is configured to rotate the shade roller in a second direction to retract the sheet around the shade roller to expose the windshield.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the shade apparatus shown in use illustrating a retracted configuration;

FIG. 2 depicts a perspective view of certain embodiments of the shade apparatus shown in use illustrating a deployed configuration;

FIG. 3 depicts a front perspective view of certain embodiments of the shade apparatus in a compact configuration;

FIG. 4 depicts a rear perspective view of certain embodiments of the shade apparatus in a compact configuration;

FIG. 5 depicts a front perspective view of certain embodiments of the shade apparatus in a fully deployed configuration;

FIG. 6 depicts a section view of certain embodiments of the shade apparatus taken along line 6-6 in FIG. 1;

FIG. 7 depicts a section view of certain embodiments of the shade apparatus;

FIG. 8 depicts a front perspective view of certain embodiments of the shade apparatus with cover 14 omitted to illustrate several internal components;

FIG. 9 depicts a front perspective view of certain embodiments of the shade apparatus with cover 14 omitted to illustrate several internal components;

FIG. 10 depicts a front schematic view of certain embodiments of the shade apparatus;

FIG. 11 depicts a perspective view of certain embodiments of the shade apparatus illustrating the remote operation of the apparatus;

FIG. 12 depicts an exploded view of certain embodiments of the shade apparatus;

FIG. 13 depicts a perspective view of an alternative embodiment of the shade apparatus; and

FIG. 14 depicts a perspective view of the alternative embodiment of the shade apparatus.

### DETAILED DESCRIPTION OF CERTAIN EMBODIMENTS

As depicted in FIGS. 1-4, shade apparatus 10 is configured to be secured to windshield 64 of vehicle 62 to block sunlight from entering the interior of the vehicle. Vehicle 62 may be any type of automobile such as a car, bus, truck, or the like, which includes steering wheel 66 and dashboard 68.

In a preferred embodiment, a pair of shade apparatuses 10 is detachably coupled to portions of windshield 64 near the top edge. In one embodiment, a first shade apparatus 10 is secured to a left portion of windshield 64 and a second shade apparatus 10 is secured to a right portion of windshield 64. It shall be appreciated that any alternative number of shade apparatuses may be used instead.

Each shade apparatus 10 generally comprises housing 12, cover 14, belt 20, motor 32, retractable sheet 34 and scissor arms 38. As will be apparent in the following detailed disclosure, scissor arms 38 are operably connected to belt 20, motor 32 and retractable sheet 34. Retractable sheet 34 is rotatably mounted to housing 12 via shaft 36 such as a drum roll, which may be spring-loaded. In one embodiment, shaft 36 is a hollow tube that is configured to roll and dispense retractable sheet 34 as desired. Retractable sheet 34 may be any type of material known in the field such as fabric.

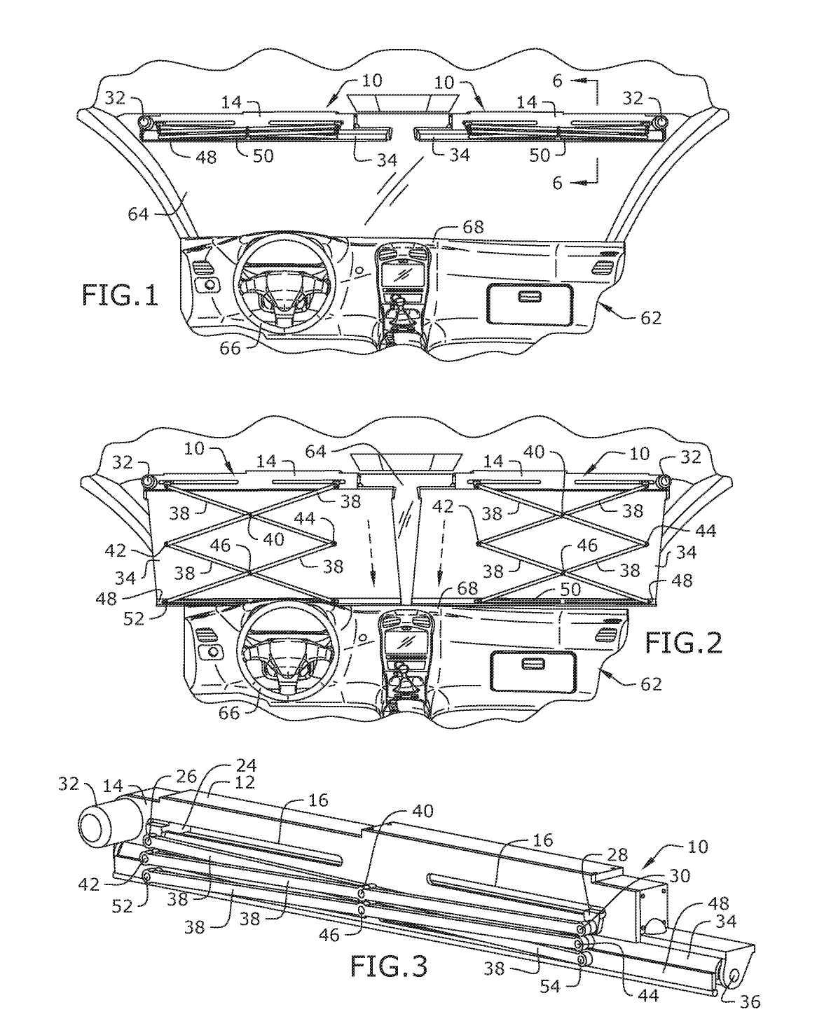

Motor 38 is configured to compress scissor arms 38 to retract retractable sheet 34 as depicted in FIG. 1 or extend scissor arms 38 to deploy retractable sheet 34 as depicted in FIG. 2. In the retracted configuration, windshield 64 is exposed and unobstructed for a driver (not shown). In the deployed configuration, the majority of windshield 64 is covered to block the entrance of sunlight into vehicle 62, including infrared, ultraviolet and visible portions of the solar spectrum.

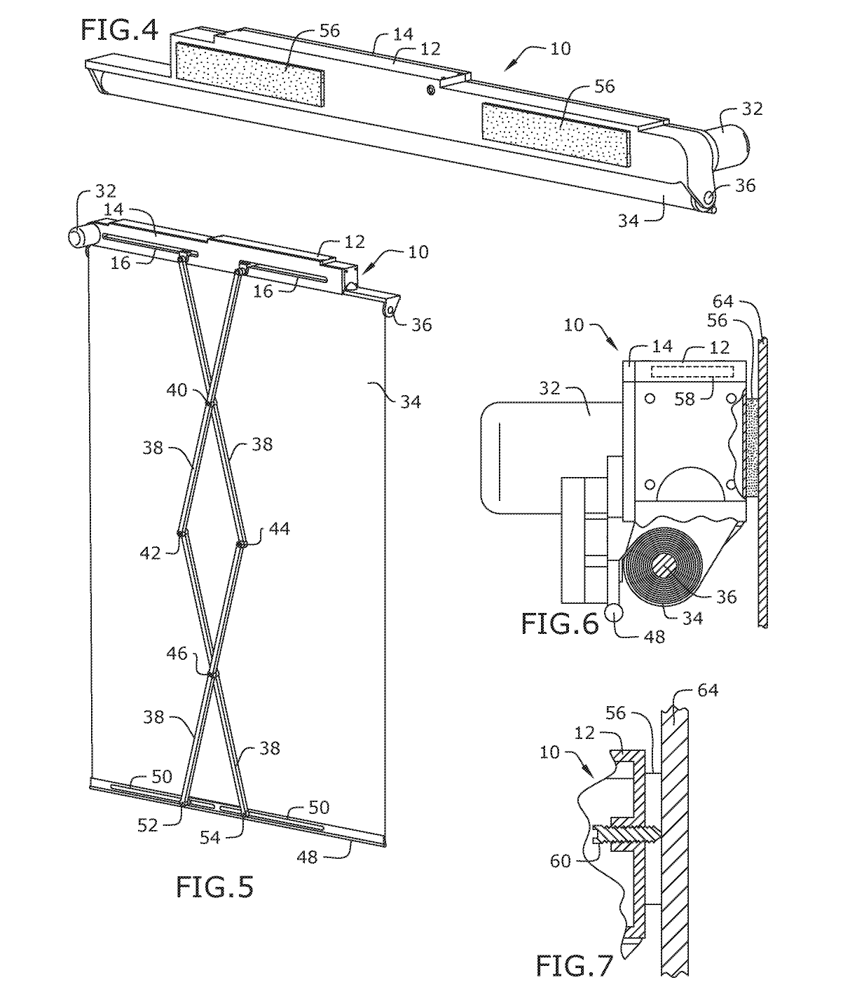

As depicted in FIGS. 4 and 6, adhesive members 56 are coupled to housing 12 and are configured to detachably couple shade apparatus 10 to windshield 64. In a preferred embodiment, threaded screw 60 is disposed through a wall of housing 12 as depicted in FIG. 7. This permits a user (not shown) to rotatably adjust threaded screw 60 until the tip is in contact with windshield 64. This ensures shade apparatus 10 remains stable when adhered to windshield 64 during its operation. Any gap between shade apparatus 10 and windshield 64 is eliminated since threaded screw 60 contacts the windshield.

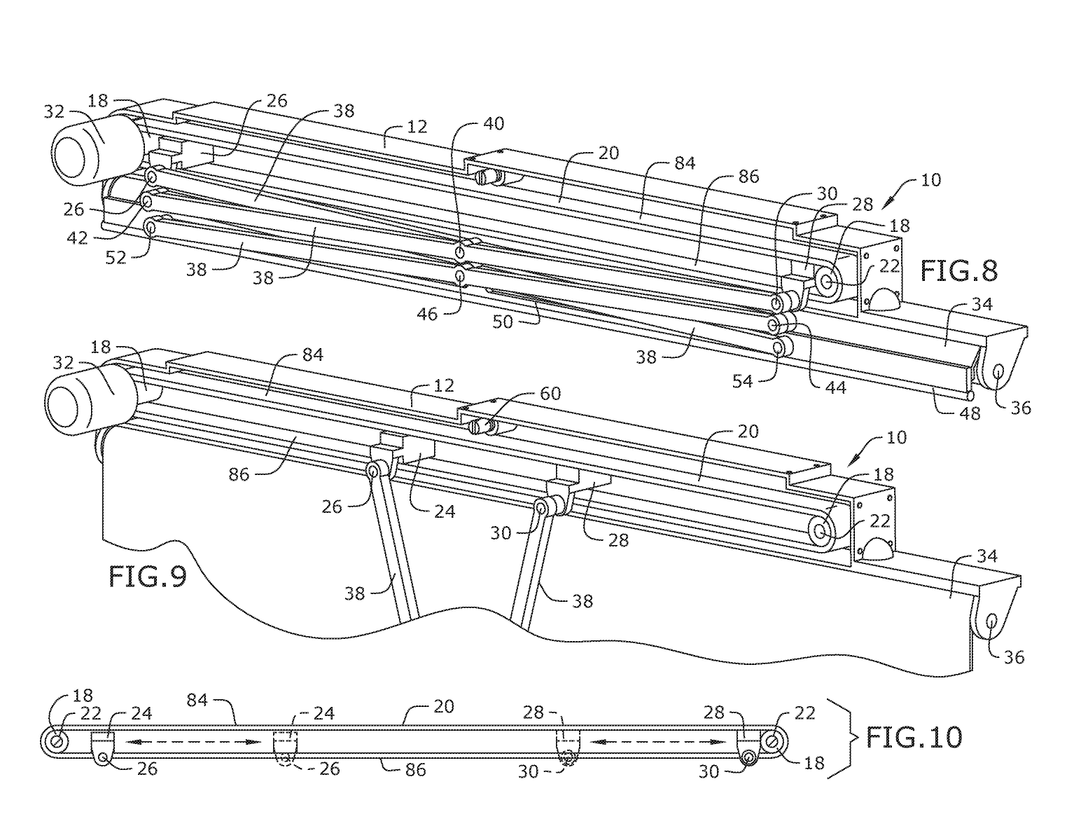

As depicted in FIGS. 8-9, housing 12 comprises a compartment configured to store belt 20, belt rollers 18 and belt roller shafts 22. Belt rollers 18 are situated on opposing ends of housing 12. Motor 32 is operably connected to one of the pair of belt rollers 18 and may comprise any mechanical components such as gears as known in the field. Motor 32 is configured to drive belt roller 18 to permit belt 20 to travel around the pair of belt rollers 18 in first direction or a second direction opposite the first direction. Motor 32 may be powered by a power source such as a battery (not shown). In one embodiment, circuit board 58 is disposed within housing 12 and is operably connected to motor 32 as shown in FIG. 6. Circuit board 58 controls the operation of motor 32.

Scissor arms 38 comprise a plurality of arm members pivotably connected to each other by connecting screws at first pivot point 40, second pivot point 42, third pivot point 44 and fourth pivot point 46. The connecting screws at pivot points 40, 42, 44, 46 permit scissor arms 38 to easily extend and collapse as needed. As depicted in FIG. 5, bottom scissor arm pivot points 52, 54 are coupled to the bottom of retractable sheet 34. More specifically, base bracket 48 is coupled to the bottom of retractable sheet 34 and comprises a pair of base bracket slots 50. Bottom scissor arm pivot points 52, 54 are disposed within base brackets slots 50 and are configured to slide horizontally therein as scissor arms 38 extend and collapse.

As depicted in FIGS. 8-9, upper scissor arm pivot points 26, 30 are connected to belt 20 by lower carriage attachment 24 and upper carriage attachment 28. Upper carriage attachment 28 is coupled to upper belt portion 84 and lower carriage attachment 24 is coupled to lower belt portion 86. In one embodiment, carriage attachments 24, 28 may be linear bearings. However, any alternative mechanical fasteners can be used to secure scissor arm pivot points 26, 30 to belt 20. Cover 14 of shade apparatus 10 comprises cover slots 16, which permit upper scissor arm pivot points 26, 30 and carriage attachments 24, 28 to slide horizontally therein as scissor arms 38 extend and collapse.

In operation, shade apparatuses 10 are installed to windshield 64 as shown in FIG. 1. Motor 32 is activated via a switch (not shown) to drive belt 20 in a first direction or a second direction as shown in FIG. 10. When drive belt 20 travels in a first direction, carriage attachments 24, 28 and upper scissor arm pivot points 26, 30 slide horizontally toward each other. This extends scissor arms 38, which deploys retractable sheet 34 as shown in FIGS. 2 and 5. When drive belt 20 travels in a second and opposite direction, carriage attachments 24, 28 and upper scissor arm pivot points 26, 30 slide horizontally away from each other. This collapses scissor arms 38, which retracts retractable sheet 34 as shown in FIG. 1.

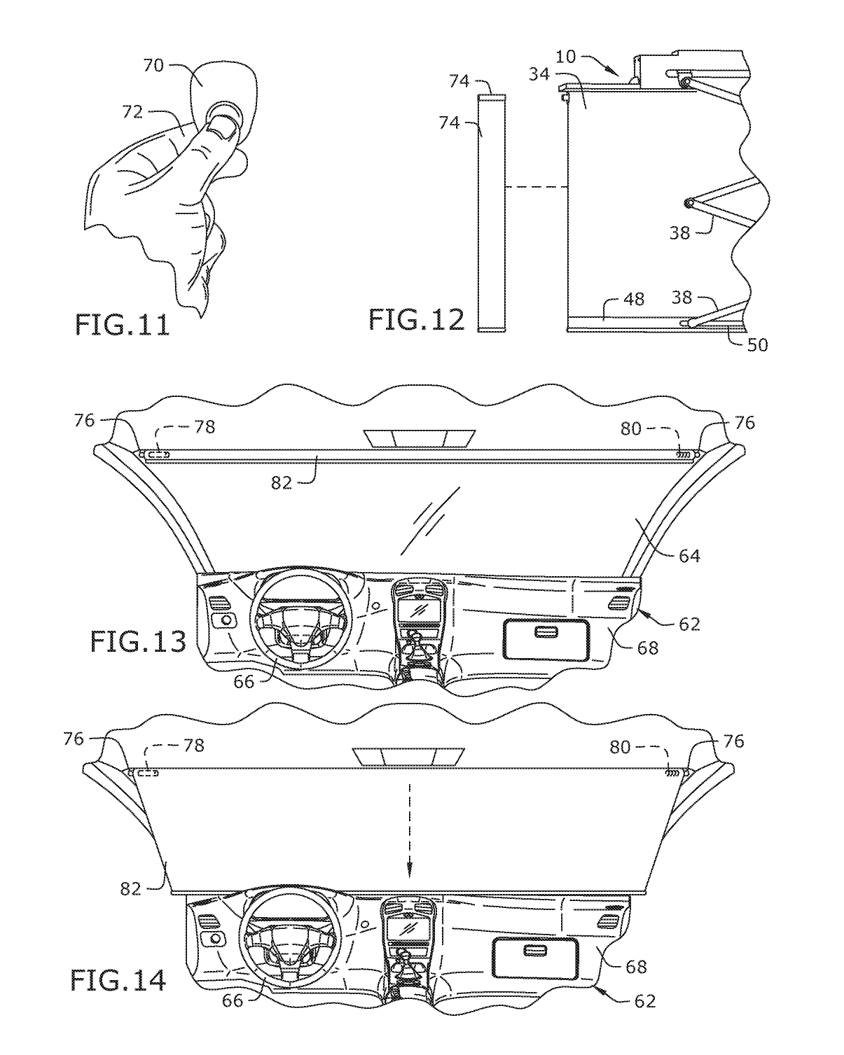

As depicted in FIG. 11, operator 72 may control the operation of any number of shade apparatuses 10 via remote control device 70. Remote control device 70 is configured to communicate with circuit board 58 of each shade apparatus 10 to deploy and retract retractable sheet 34 as needed. In an alternative embodiment, operator 72 may control the operation of shade apparatus 10 manually by a switch (not shown) on motor 32.

As depicted in FIG. 12, one or more extension members 74 may be coupled to retractable sheet 34 by any fastening components known in the field. Extension member 74 is preferably a retractable sheet disposed around a shaft such as a drum roll, which is spring-loaded. Extension member 74 may have variable dimensions and is configured to be secured to either the left or right sides of retractable sheet 34. Extension member 74 is beneficial because it covers any additional exposed areas on windshield 64 omitted by retractable sheet 34. Since each extension member 74 is coupled to retractable sheet 34, extension member 74 deploys and retracts when retractable sheet 34 deploys and retracts.

Several design modifications can be made to shade apparatus 10. In an alternative embodiment, retractable shade roller 82 is secured to windshield 64 as shown in FIG. 13. Retractable shade roller 82 is disposed around hollow rod members 76, which can be spring-loaded by spring 80. Alternate DC motor 78 is operably connected to one of hollow rod members 76 and is configured to rotate the rod member in a first direction or a second direction as needed, thereby deploying or retracting retractable shade roller 82 as desired. FIG. 14 depicts retractable shade roller 82 in the deployed position. This alternate configuration of a shade apparatus removes the need for scissor arms 38, and is therefore a more simple design.

It shall be appreciated that the shade apparatuses described herein provide a barrier against the effects of the sun by completely covering a vehicle's windshield or rear windshield to prevent or reduce sunlight from entering and degrading interior components made of fabric, leather or polymers. Further, the shade apparatuses may restrict the generation of heat in the interior of a vehicle, thereby reducing the ambient temperature for efficient functioning of air conditioning, cooler seats and steering wheel, etc., and reduce the “oven” effect in summer and hot weather conditions.

It shall be appreciated that the components of the shade apparatuses described in several embodiments herein may comprise any known materials in the field and be of any color, size and/or dimensions. It shall be appreciated that the components of the shade apparatuses described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An automated shade apparatus detachably coupled to a windshield of a vehicle and configured to deploy or retract with enhanced efficiency, the shade apparatus configured to permit a user to control the amount of sunlight that enters the vehicle with reduced user effort, the shade apparatus comprising:
a housing coupled to the windshield of the vehicle, the housing comprising a pair of openings both extending along a longitudinal axis of the housing;
a drive assembly disposed within the housing and comprising a belt disposed around a pair of rollers, at least one of the rollers configured to be driven by a motor to permit the belt to travel around the rollers;
a retractable shade roller coupled to the housing and comprising a sheet disposed around the shade roller; and
a collapsible scissor arm assembly coupled to the housing and comprising a plurality of arms pivotably mounted together, the plurality of arms comprising a pair of top ends disposed through the pair of openings in the housing and coupled to the belt and a pair of bottom ends coupled to an end of the sheet;
wherein the motor is configured to drive the belt in a first direction to extend the plurality of arms, thereby deploying the sheet over the windshield, wherein the motor is configured to drive the belt in a second direction to collapse the plurality of arms, thereby retracting the sheet around the shade roller to expose the windshield.

2. The shade apparatus of claim 1, further comprising a bracket coupled to the end of the sheet and comprising a pair of slots, wherein the pair of bottom ends of the arms are disposed through the pair of slots.

3. The shade apparatus of claim 2, wherein each top end of the plurality of arms is coupled to the belt by a carriage member coupled to the belt.

4. The shade apparatus of claim 3, wherein each top end of the plurality of arms is pivotably mounted to the carriage member.

5. The shade apparatus of claim 4, wherein the housing is coupled to the windshield by an adhesive.

6. The shade apparatus of claim 5, further comprising a rotatable screw coupled to the housing member and configured to contact the windshield.

7. The shade apparatus of claim 6, further comprising an extension shade roller coupled to the retractable shade roller and configured to retract and deploy when the retractable shade roller retracts and deploys,

8. The shade apparatus of claim 7, further comprising a circuit board disposed within the housing and operably connected to the motor.

9. The shade apparatus of claim 8, further comprising a remote control device operably connected to the circuit board and configured to control an operation of the motor.

10. An automated shade apparatus detachably coupled to a windshield of a vehicle and configured to deploy or retract with enhanced efficiency, the shade apparatus configured to permit a user to control the amount of sunlight that enter the vehicle with reduced user effort, the shade apparatus comprising:
a retractable shade roller coupled to the housing and comprising a sheet disposed around the shade roller; and
a motor operably connected to the retractable shade roller, wherein the motor is configured to rotate the shade roller in a first direction to deploy the sheet to cover any portion of the windshield, wherein the motor is configured to rotate the shade roller in a second direction to retract the sheet around the shade roller to expose the windshield.
